(19) United States
(12) Patent Application Publication
(10) Pub. No.: US 2001/0031229 A1
(43) Pub. Date: Oct. 18, 2001

(54) UV-enhanced, in-line, infrared phosphorous diffusion furnace

(76) Inventors: Reed E. Spjut, Alta Loma, CA (US); Raymond T. Kruzek, Rancho Palos Verdes, CA (US); Carson T. Richert, Corona, CA (US); Andrei Szilagyi, Rancho Palos Verdes, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/795,667

(22) Filed: Feb. 26, 2001

Related U.S. Application Data
(63) Continuation-in-part of application No. 09/621,366, filed on Jul. 21, 2000.
Application No. 09/621,366 is a continuation of application No. 09/483,541, filed on Jan. 14, 2000, now abandoned.
Application No. 09/483,541 is a continuation of application No. 09/421,805, filed on Oct. 20, 1999, now abandoned.
(60) Provisional application No. 60/104,945, filed on Oct. 20, 1998.

(51) Int. Cl. B01J 19/08

(52) U.S. Cl. 422/186.3

(57) ABSTRACT

A thermal processing apparatus for thermally processing a workpiece having a process chamber, a workpiece support positioned inside of the process chamber, a heater positioned inside of the process chamber to heat the workpiece; and an ultraviolet light source positioned inside of the process chamber to irradiate ultraviolet light onto the workpiece.

### CROSS-REFERENCE TO RELATED APPLICATION(S)

This application is a continuation-in-part of U.S. patent application Ser. No. 09/621,366, filed on Jul. 21, 2000, which is a continuation of U.S. patent application Ser. No. 09/483,541, filed on Jan. 14, 2000, now abandoned, which is a continuation of U.S. patent application Ser. No. 09/421,805, filed on Oct. 20, 1999, now abandoned, which claims priority of provisional Application No. 60/104,945, filed on Oct. 20, 1998, the disclosures of which are incorporated fully herein by reference.

### BACKGROUND OF THE INVENTION

In the manufacture of some photovoltaic cells (solar cells), a compound containing phosphorus is applied to one surface of a silicon wafer. The wafer is then subjected to a thermal process to diffuse or drive the phosphorus into the interior of the wafer for purposes of forming a p-n junction. Throughout the photovoltaic industry, this diffusion process is usually done in either a tube furnace as a batch process or in a conventional quartz-muffle belt furnace as a continuous in-line process.

The addition of ultraviolet (“UV”) light to the thermal processing unit has been found to enhance the diffusion of phosphorus into the interior of the wafer and the quality of the resulting photovoltaic cell. Thus, there is a need for a thermal diffusion device that also provides UV light to the wafer.

### SUMMARY OF THE INVENTION

The present invention provides a way to introduce UV light into a thermal-processing furnace for performing UV-enhanced thermal processing of silicon and other semiconductor substrates, and for all other such uses where ultraviolet light would enhance thermal processing.

A thermal processing apparatus for thermally processing a workpiece according to an embodiment of the present invention has a process chamber and a workpiece support positioned inside of the process chamber. Also inside of the process chamber is a heater which heats the workpiece, and an ultraviolet light source which irradiates ultraviolet light onto the workpiece. The ultraviolet light source has a cooling jacket and an ultraviolet lamp having an ultraviolet discharge tube positioned inside of the cooling jacket. A support holds the ultraviolet light source inside of the cooling jacket. A coolant circulation system circulates a coolant through a coolant space inside of the cooling jacket.

In an additional embodiment of the present invention, the thermal processing apparatus has a sensor for sensing at least one of the group consisting of whether the ultraviolet lamp is on or off, how much voltage the ultraviolet lamp is using, how much current the ultraviolet lamp is using, a temperature of the coolant exiting the cooling jacket, a volume of coolant flowing through the cooling jacket, a humidity inside of plenum boxes where the ultraviolet lamp and a cooling jacket are mounted, and a temperature inside of the heating chamber. Additionally, the thermal processing apparatus has a controller that controls the output of both the heater and the ultraviolet lamp.

In another embodiment of the present invention the workpiece support is a conveyor belt. The conveyor belt may be made of corrosion resistant ceramic. Alternatively, the conveyor belt may be made of corrosion-resistant metal. If a metal conveyor belt is used, then standoffs of ceramic or quartz may be used to separate the workpiece from the conveyor belt.

A thermal processing apparatus according to an embodiment of the present invention may have a controlled atmosphere in the processing chamber. In order to control the atmosphere in the processing chamber, the chamber is built with insulated walls and an atmosphere control system that provides a controlled gas into the process chamber through the insulated walls. Entrance and exit baffles may also be used to prevent unwanted gas from entering into the processing chamber.

In an embodiment, the heater used to heat the workpiece is an infrared heater. The infrared heater is a tubular tungsten-halogen lamp. Several, tubular tungsten-halogen lamps are arranged above and below the conveyor belt to heat a workpiece.

In an embodiment, the cooling jacket of the ultraviolet light source is sealed to the walls of the process chamber using seals. The seals between the cooling jacket and the process chamber are made of heat-resistant fibrous packing material. In an alternative embodiment, the seals between the cooling jacket and the process chamber are made of quartz wool.

In one embodiment of the present invention, the cooling jacket comprises two shells fused together at a first end and a second end defining a space in between the shells. In an additional embodiment, the two shells are concentric and coaxial cylindrical quartz shells, and the shells are fused together at a first end and at a second end defining an elongated annular space. The elongated annular space is accessible at the first end through an inlet and at the second end through an outlet. In an additional embodiment, quartz tubes are fused to both the inlet and the outlet in fluid communication with the elongated annular space of the cooling jacket. In another embodiment, both the inlet and the outlet are coupled to the coolant circulation system by flexible tubing. In yet another embodiment, the flexible tubing is made of silicone rubber.

The ultraviolet lamp is supported within the cooling jacket by metallic strips and coolant is circulated through the cooling jacket by the coolant circulation system. In one embodiment, the coolant is air. In an alternative embodiment, the coolant is water.

### BRIEF DESCRIPTION OF THE DRAWINGS

These and other features and advantages of the present invention will be better understood by reference to the following detailed description when considered in conjunction with the accompanying drawings wherein:

FIG. 1 is a perspective view of a UV enhanced, thermal processing apparatus according to an embodiment of the present invention;

FIG. 2 is a perspective view of the exterior of a heating chamber according to an embodiment of the present invention;

FIG. 3 is a perspective view showing the inside of a heating chamber according to an embodiment of the present invention;

FIG. 4 is a side cross sectional view of a heating chamber according to an embodiment of the present invention;

FIG. 5 is a cross sectional view of a gas cooled UV lamp situated in the heating chamber according to an embodiment of the present invention;

FIG. 6 is a side view of an end of a liquid cooled UV lamp with one inlet according to an embodiment of the present invention;

FIG. 7 is a plan view showing a liquid cooled UV lamp with one inlet and one outlet according to an embodiment of the present invention;

FIG. 8 is an end view of a liquid cooled UV lamp with one inlet according to an embodiment of the present invention;

FIG. 9 is a side view of an end of a liquid cooled UV lamp with two inlets according to an embodiment of the present invention;

FIG. 10 is a plan view showing a liquid cooled UV lamp with two inlets and two outlets according to an embodiment of the present invention;

FIG. 11 is an end view of a liquid cooled UV lamp with two inlets according to an embodiment of the present invention;

FIG. 12 is a cross sectional view of a liquid cooled UV lamp with one inlet and two outlets according to an embodiment of the present invention;

FIG. 13 is a perspective view of a UV enhanced, thermal processing apparatus according to an alternative embodiment of the present invention.

### DETAILED DESCRIPTION OF THE INVENTION

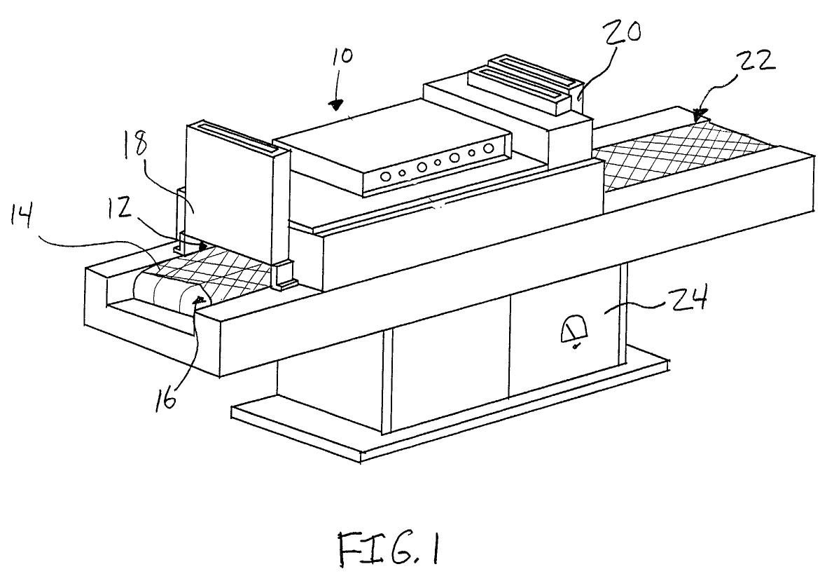

FIG. 1 shows a UV enhanced phosphorus diffusion furnace 10 according to an embodiment of the present invention. The furnace 10 has a tunnel 12 through which the parts being processed are transported on a conveyance system 14 or other transport mechanism. The conveyance system 14 moves the parts from a loading station 16 though an entry baffle 18 into a heating chamber. Inside of the heating chamber, the part is exposed to heat and UV light as described below. The conveyance system 14 then moves the part through an exit baffle 20 to an unloading station 22. In an embodiment of the present invention, the furnace is constructed as shown in U.S. patent application Ser. No. 4,517,448, issued on May 14, 1985, the entire disclosure of which is incorporated herein by reference. The furnace has a pedestal 24 upon which is provided a lower framework having access doors. Mounted on the top of the lower framework, inwardly from the ends thereof, is a shorter upper framework. The enclosure for the upper framework is also provided with access doors. A heating chamber is supported within the lower and upper frameworks.

The heating chamber is an elongated rectangularly shaped enclosure having its upper and lower walls constructed of sheets of insulation, and having its side walls constructed of sheets of insulation. The heating chamber is divided by a conveyance system and insulation surrounding the conveyance system. In an embodiment, the conveyance system is supported to ride within the heating chamber on three quartz tubes which extend throughout the length of the heating chamber and rest on three semicircular grooves provided on the end walls. The sheets of insulation are formed by compressing a heat insulating material, such as a white alumina fiber, so that it forms a porous structural wall having a relatively smooth surface.

In an embodiment, the conveyance system 14 is a motorized endless conveyor belt. The conveyor belt may be a corrosion-resistant metallic mesh belt. The conveyor belt may have ceramic or quartz standoffs for preventing the diffusion of impurities from the metal mesh to a semiconductor workpiece. Alternatively, the conveyor belt may be a corrosion-resistant ceramic link belt. The ceramic material in the ceramic link belt is free of impurities that could harm a semiconductor workpiece.

A cover gas, which may be nitrogen or hydrogen for example, may be fed under a low pressure to the heating chamber. A system for administering a cover gas to the system is described in U.S. Pat. No. 4,517,448. In this system, the cover gas slowly and evenly filters through the porous sheets of insulation which form the top and bottom walls of the heating chamber, thus causing the interior of the heating chamber to be at a slightly higher pressure than the atmosphere surrounding the infrared furnace. The increased pressure in the heating chamber keeps unwanted air from entering the heating chamber and causing unwanted reactions.

A workpiece is loaded onto the conveyance system 14 at the loading station 16. Once the workpiece is loaded onto the conveyance system 14, the workpiece travels through an entry baffle 18 and into the heating chamber 12. The entry baffle 18 keeps any room air from entering into the heating chamber 12. An exemplary baffle is described in U.S. Pat. No. 4,517,448. In one embodiment, the entry baffle 18 comprises a stationary physical barrier to prevent room atmosphere from entering the furnace. The entry baffle 18 also contains air knives that function by jetting an inert gas downward toward the conveyance system 14, forming a barrier to prevent room air from entering into the heating chamber 12. In an additional embodiment, there are air knives oriented upward that jet an inert gas upward toward the conveyance system 14.

Also in the loading portion of the heat chamber 12 is a powered exhaust stack(not shown). An exemplary powered exhaust stack is described in U.S. Pat. No. 4,517,448. In an embodiment of the present invention, an upward draft is created in the powered exhaust stack by blowing a gas upward and out of the top of the powered exhaust stack. The blowing of a gas upward and out of the powered exhaust stack creates suction to draw exhaust gasses from the heating chamber and send these exhaust gasses out of the powered exhaust stack. As some of the gas from the heating chamber reaches the powered exhaust stack, the gas is cooled and waste products in the gas condense out onto the walls of the powered exhaust stack.

Below the powered exhaust stack is a plate that collects the drippings of the exhaust gasses that condense at the bottom of the powered exhaust stack. The plate may be removed for cleaning by removing an outer panel of the upper frame. The use of a controlled atmosphere and a powered exhaust stack prevents oxidation and removes the fluxes that evaporate off of the workpiece. The controlled atmosphere may comprise, for example, nitrogen or hydrogen. In an alternative embodiment, the controlled atmosphere comprises clean dry air (“CDA”).

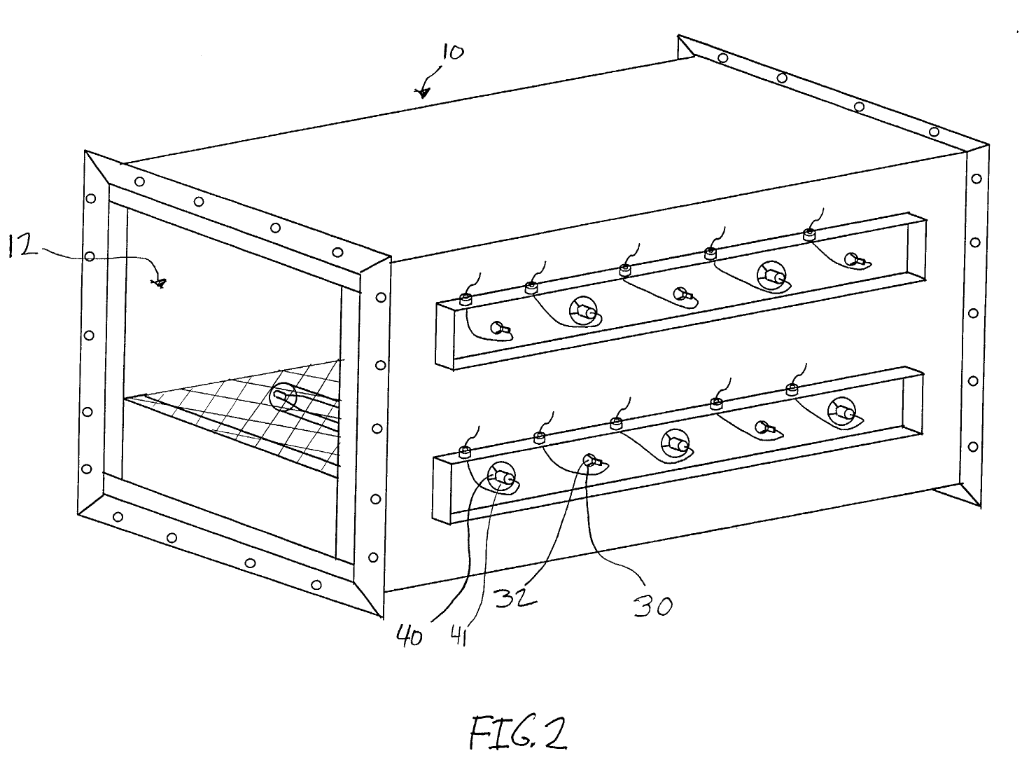

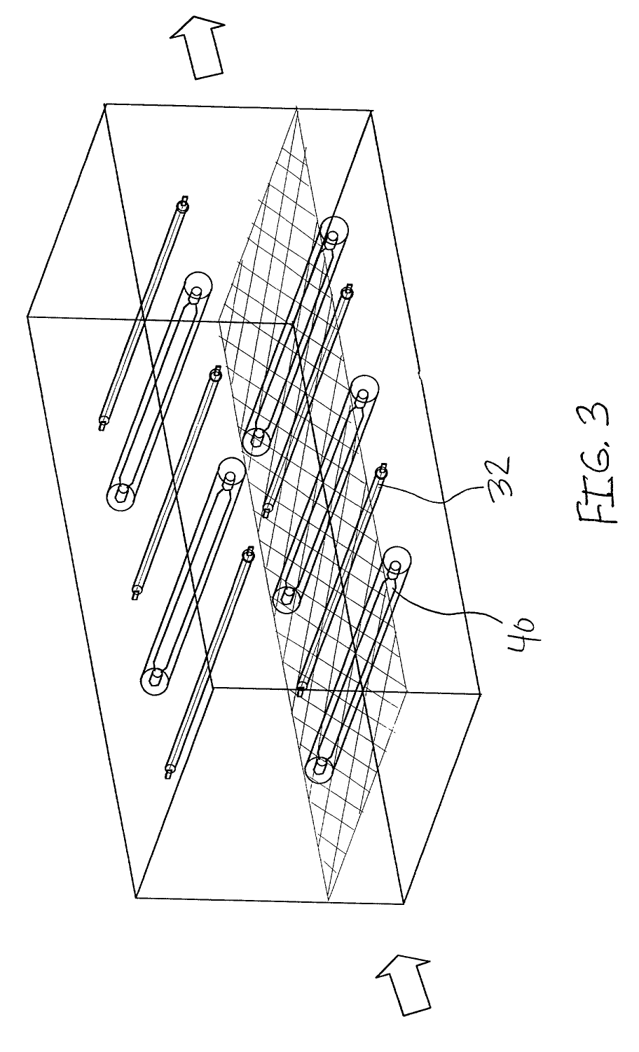

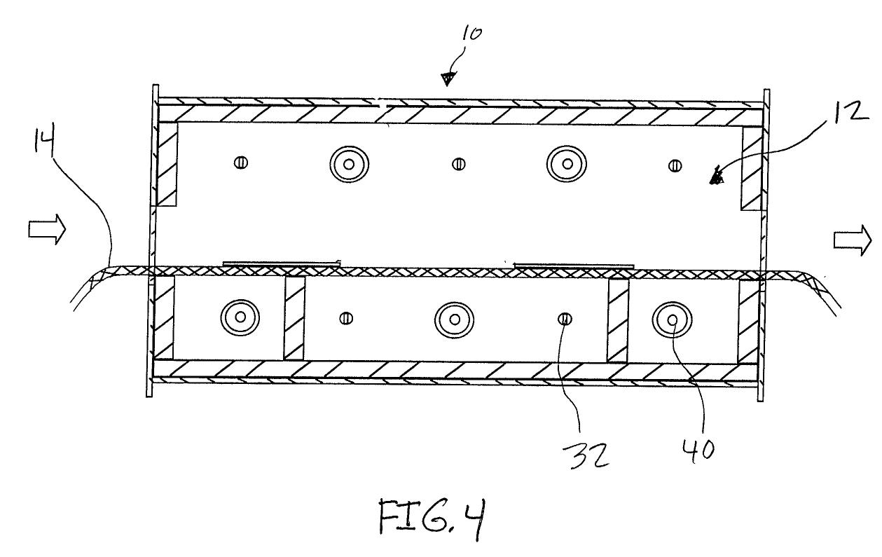

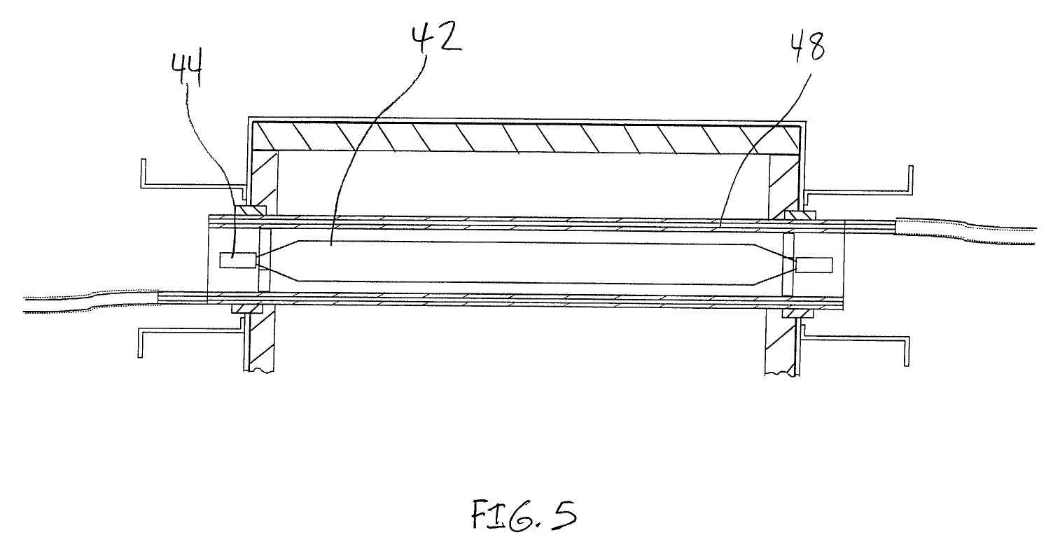

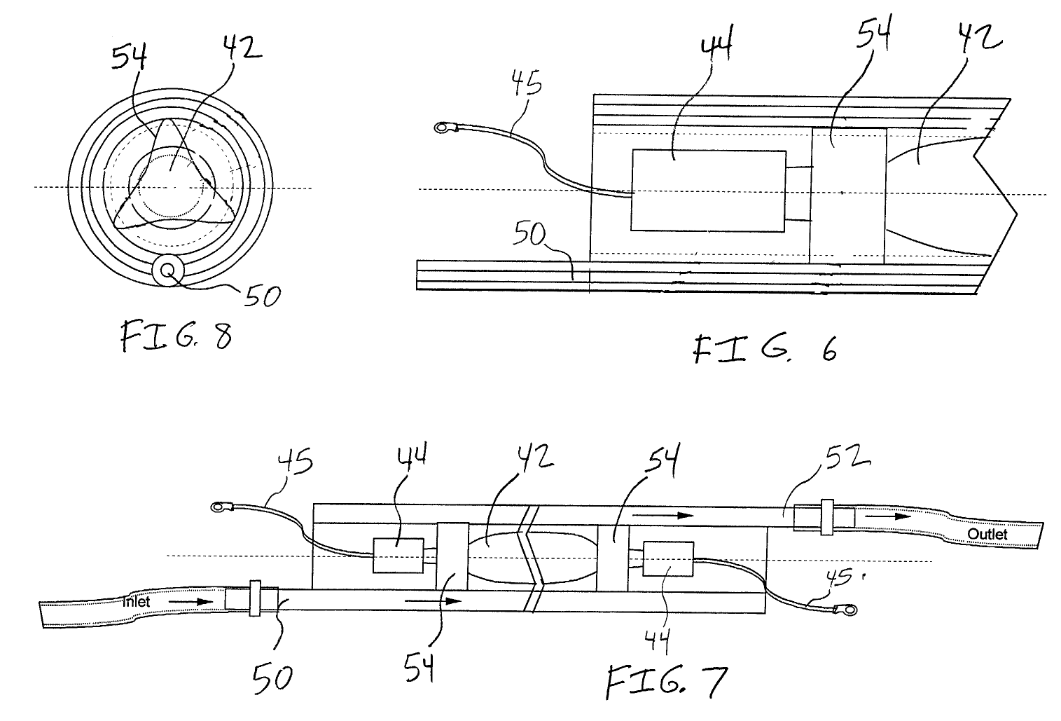

As shown in FIGS. 2 and 3, each of the side walls of the heating chamber is provided with circular holes 30 both above and below the heating belt. A plurality of elongated infrared lamps 32 are mounted within the circular holes 30. A mounting for the infrared lamps is disclosed in U.S. Pat. No. 4,517,448. In one embodiment, the infrared lamps are tubular tungsten-halogen lamps. Each lamp is located either above or below the belt, and the lamps below the belt can be operated independently of the lamps above the belt.

In a first embodiment of the present invention, shown in FIGS. 2 to 4, one or more high-intensity UV lamps 40 are placed inside the heating chamber to provide UV light to a workpiece. The UV lamps 40 are extended through a plurality of circular holes 41 in the side walls of the heating chamber. The UV lamps 40 may be arranged transverse to the direction of transport in alternating fashion with the IR lamps 32, i.e., IR lamp, UV lamp, IR lamp, UV lamp, etc. As with the IR lamps 32, the UV lamps 40 may be mounted above and below the conveyor belt carrying the workpieces. As with the IR lamps 32, the UV lamps 40 located above the conveyor belt may be controlled separately from the those UV lamps 40 located below the conveyor belt. The UV light generated by the UV lamps may be reflected off of the walls of the chamber, or the UV light may be focused onto the upper and lower surfaces of a workpiece.

As shown in FIG. 5, each UV lamp 40 has a UV discharge tube 42 with ceramic sealed end caps 44 at each end of the discharge tube 42. The UV discharge tube 42 contains a high-intensity UV-rich light source, such as a deuterium lamp, xenon arc lamp or mercury-xenon arc lamp. The end caps 44 seal the discharge tube and provide an electrical connection to electrodes located within the tube. A power source is connected to the end caps 44 through power wires 45. Preferably, each UV lamp is surrounded by a hollow cooling jacket 48 that is concentric with the UV lamp. In an embodiment, the cooling jacket is created by fusing two concentric and coaxial cylindrical quartz shells together. The cylindrical quartz shells are fused at their ends to create an elongated annular space between the shells. In addition to quartz, the cooling jacket may be created from other high temperature withstanding, UV-light transparent materials.

As shown in FIGS. 6 to 8, the shells are fused so as to create a first opening 50 to the elongated annular space between the cylindrical shells at a first end. The first opening 50 functions as an inlet for coolant. The shells are also fused so as to create a second opening 52 to the elongated annular space between the cylindrical shells at a second end. The second opening 52 functions as an outlet for coolant. Other types of cooling jackets may be used, for example, cooling jackets that are preformed from one piece of material and cooling jackets that are non-cylindrically shaped. Additionally, a cooling jacket may be configured to have both an inlet and an outlet at the same end, with a coolant path inside of the cooling jacket that ensures circulation around the discharge tube.

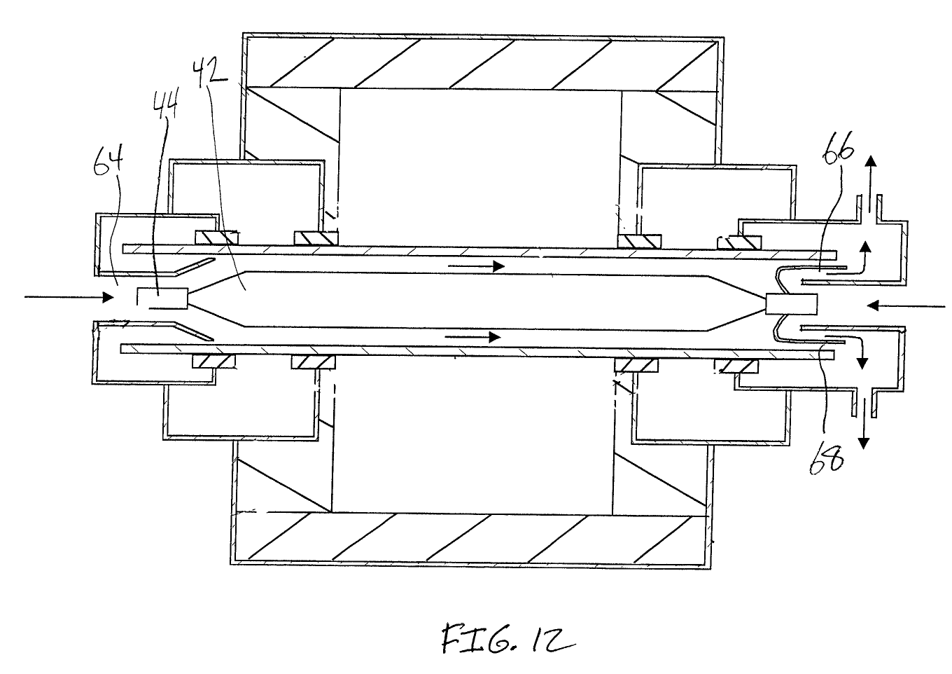

As shown in FIGS. 8 and 11, the discharge tube is held within the inner cylindrical shell using heat and corrosion resistant metal strips 54 at each end, inward of each end cap. The strips are folded to form a three pointed star shaped holder. The inside surfaces of the star shaped holder circumscribe and cradle the discharge tube 42. The pointed tips of the star shaped holder are resiliently inscribed against the inner wall of the cooling jacket 48.

In an embodiment, a separate quartz tube may be fused to each of the first and second openings of the cylindrical shells to provide thermal contact with the elongated annular space between the cylindrical shells to allow for convective cooling. Alternatively, separate flexible tubing made of heat resistant material, such as silicone rubber, may be connected to each of the first and second openings of the cylindrical shells to provide thermal contact with the elongated space between the cylindrical shells. The coolant may be air or water. Additionally, the coolant may be any other UV-transparent, high-boiling point, heat-absorbing liquid.

The cooling jacket extends through the wall of the heating chamber so that the inlet and outlets are located outside of the heating chamber. The inlet is connected to a coolant source. The outlet may be connected to a coolant cooler, a venting system, or a recycling system for later reuse. Coolant is circulated through the annular space in the cooling jacket by a blower or pump. A coolant temperature sensor may also be placed in thermal contact with the coolant to monitor the temperature of the coolant. A flow rate sensor may also be placed in contact with the coolant to monitor the volume of coolant being pumped through the cooling jacket. The coolant temperature sensor and flow rate sensor may be in communication with a controller. Depending on the temperature of the coolant as determined by the sensor, or the rate of coolant detected by the flow sensor, coolant flow may be altered, power to a UV discharge tube may be switched off, and power to the heaters in the heating chamber may be switched off to prevent damage to the UV discharge tube.

In an additional embodiment, because the discharge tube sits within the cooling jacket, and because liquid coolant may have an adverse reaction with the electricity passed to the discharge tube, a gas flushing system and humidity sensor are employed. The end caps are located within plenum boxes inside of the cooling jacket. The plenum box is flushed with dry nitrogen to remove humid air surrounding the end cap. The humidity sensor senses the level of humidity within the plenum box. The humidity sensor is in communication with the controller. The controller does not allow electricity to flow to the UV-light source until the humidity sensor indicates that the humidity level in the plenum box is below a preselected level.

In an additional embodiment, thermocouples are positioned inside of the heating chamber. The thermocouples are in communication with the controller. If the thermocouples detect a temperature inside of the heating chamber in excess of a predetermined temperature, the controller removes power to the furnace to prevent damage to the workpieces and to the furnace.

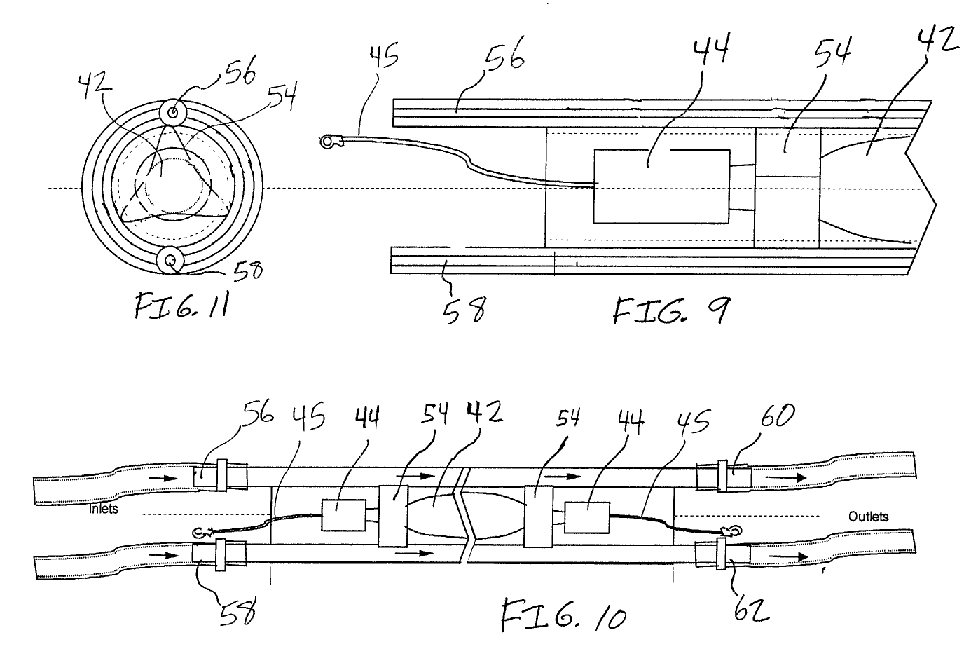

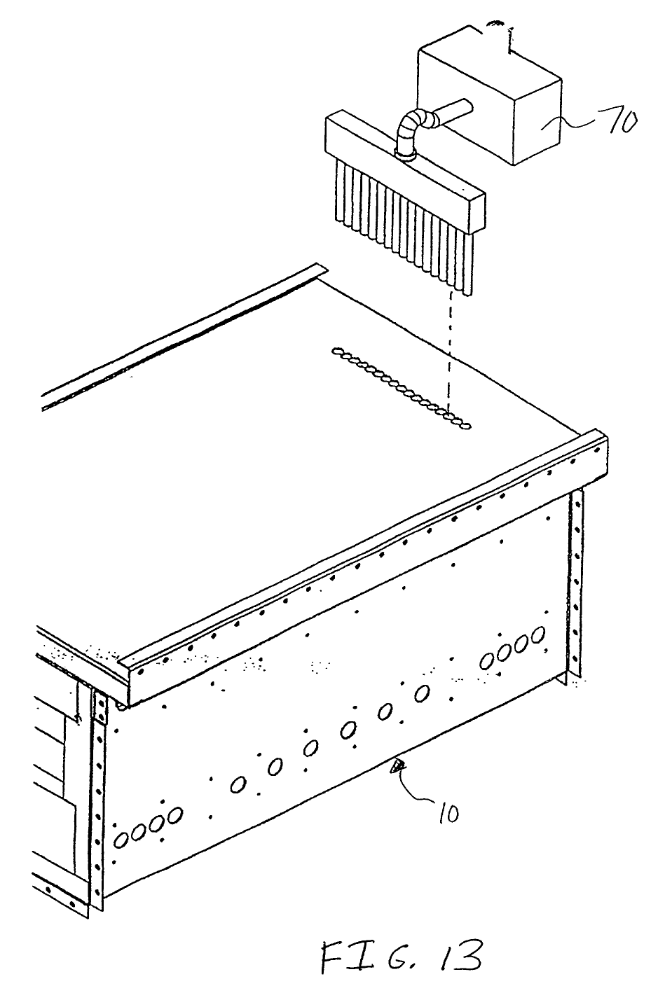

In additional embodiments of the present invention the number of inlets or outlets in the cooling jacket are changed. In an embodiment, shown in FIGS. 9 to 11, the hollow cooling jacket has two inlets 56, 58 and two outlets 60, 62 for coolant. In another embodiment, shown in FIG. 12, the hollow cooling jacket has one inlet 64 and two outlets 66, 68.

The outer cylindrical shell of the cooling jacket 48 is sealed within the circular holes 41 in the side walls of the heating chamber 12. The seals between the cooling jacket 48 and the walls of the heating chamber 12 may be made of heat-resistant fibrous packing material. In an embodiment, the seals between the cooling jacket 48 and the walls of the heating chamber 12 are made of quartz wool.

In an alternative embodiment of the present invention, shown in FIG. 13, a UV-rich light source 70, such as a deuterium lamp, xenon arc lamp or mercury-xenon arc lamp, is positioned outside of the heating chamber. The light from the UV-rich light source 70 is transmitted to the inside of the heating chamber by high-temperature, fiber-optic cable or cables, such as quartz-on-quartz fibers. The fibers can be arranged across the tunnel in such a way as to uniformly illuminate the width of the processing area. By positioning the UV-rich light source outside of the heating chamber, the problem of controlling the temperature of the UV-rich light source is reduced.

The conveyance system moves the belt through the heating chamber and through an exit baffle 20 which serves to seal off the tunnel from room air on the exiting side of the furnace in the same way as the entry baffle on the entrance side. In an embodiment of the present invention, a second powered exhaust stack and drip pan are located on the exiting side of the furnace, and function the same as the powered exhaust stack and drip pan in the entry area, as described above. In one embodiment of the present invention, the different powered exhaust stacks are used together. In an alternative embodiment of the present invention, only one of the two powered exhaust stacks is used at a time. In yet another embodiment of the present invention, the use of the powered exhaust stacks is alternated so that the production is halted less often for cleaning of the drip pans.

Once the workpiece travels through the exit baffle 20 the workpiece is transported to an unloading station 22. Once the workpiece reaches the unloading station 22, the workpiece can either be removed from the conveyance system by hand or automatically. In an embodiment of the present invention, the wafer is automatically placed into a cassette.

At least one sensor may be located within the heating chamber to monitor the temperature of the heating zone. Additionally, at least one sensor may be located within the heating chamber to monitor the amount of ultraviolet light delivered to the heating zone. Further, at least one sensor may be electrically connected to the UV light source to monitor whether the UV light source is on and how much power the UV light source is using.

In an embodiment, the infrared lights and ultraviolet lights may be connected to a controller. The controller, alone or in combination with the above described sensors, controls the amount of heat and ultraviolet light that is applied to a workpiece. In an embodiment of the present invention, the controller circuitry is stored in the pedestal 24 and is coupled to an external display and input device for user control.

The furnace of the present invention may be used, for example, in the preparation of diffused junctions in solar cells, rapid thermal oxidation (RTO), rapid thermal annealing (RTA), annealing of gate oxide, and photo-assisted activation or decomposition of reactants in chemical vapor deposition (CVD) systems.

The preceding description has been presented with reference to the presently preferred embodiments of the invention shown in the drawings. Workers skilled in the art and technology to which this invention pertains will appreciate that alterations and changes in the described structures can be practiced without departing from the spirit, principles and scope of this invention.

Accordingly, the foregoing description should not be read as pertaining only to the precise structure described, but rather should be read consistent with, and as support for the following claims.

What is claimed is:

1. An apparatus for thermally processing a workpiece comprising:
a process chamber;
a workpiece support positioned inside of the process chamber;
a heater positioned inside of the process chamber to heat the workpiece; and
an ultraviolet light source positioned inside of the process chamber to irradiate ultraviolet light onto the workpiece.

2. An apparatus according to claim 1 wherein the ultraviolet light source further comprises
a cooling jacket having a coolant space;
an ultraviolet lamp having an ultraviolet discharge tube positioned inside of the cooling jacket;
a support holding the ultraviolet light source inside of the cooling jacket;
a coolant; and
a coolant circulation system that circulates the coolant in the coolant space of the cooling jacket.

3. An apparatus according to claim 2 further comprising:
a sensor that senses at least one of the group consisting of whether the ultraviolet lamp is on, an amount of voltage the ultraviolet lamp is using, an amount of current the ultraviolet lamp is using, a temperature of the coolant; a flow rate of the coolant, a humidity surrounding the ultraviolet lamp, and a temperature inside of the process chamber;
a controller that controls the output of the heater, the output of the ultraviolet lamp and the coolant circulation system;
wherein the controller alters the output of at least one of the group consisting of the heater, the coolant circulation system and the ultraviolet lamp depending on information received from the sensor.

4. An apparatus according to claim 1 wherein the workpiece support is a conveyor belt.

5. An apparatus according to claim 4 wherein the conveyor belt comprises corrosion resistant ceramic.

6. A thermal processing apparatus according to claim 4 wherein the conveyor belt comprises corrosion-resistant metal.

7. An apparatus according to claim 6 wherein the conveyor belt comprises standoffs of at least one of the group consisting of ceramic and quartz for separating the workpiece from the conveyor belt.

8. An apparatus according to claim 4 wherein the process chamber further comprises:
insulated walls; and
an atmosphere control system that provides a controlled gas into the process chamber through the insulated walls.

9. An apparatus according to claim 8 wherein the heater further comprises an infrared heater.

10. An apparatus according to claim 9 wherein the infrared heater further comprises a tubular tungsten-halogen lamp.

11. An apparatus according to claim 8 wherein the heater further comprises a plurality of tubular tungsten-halogen lamps arranged above and below the conveyor belt.

12. An apparatus according to claim 2, further comprising seals between the cooling jacket and the process chamber; wherein the seals comprise at least one of the group consisting of heat-resistant fibrous packing material and quartz wool.

13. An apparatus according to claim 2, wherein the cooling jacket comprises two shells fused together at a first end and at a second end defining a coolant space between the shells; wherein the coolant space is accessible through an inlet and through an outlet.

14. An apparatus according to claim 2, wherein the cooling jacket comprises two concentric and coaxial cylindrical quartz shells fused together at a first end and at a second end defining an elongated annular coolant space; wherein the elongated annular coolant space is accessible at the first end through an inlet and at a second end through an outlet.

15. An apparatus according to claim 14, wherein both the inlet and the outlet comprise quartz tubes, fused in thermal contact with the elongated annular space of the cooling jacket.

16. An apparatus according to claim 14, wherein both the inlet and the outlet are coupled to said coolant circulation system by flexible tubing.

17. An apparatus according to 16, wherein the flexible tubing comprises silicone rubber.

18. An apparatus according to claim 2, wherein the coolant comprises at least one of the group consisting of air and water.

19. An apparatus according to claim 2, wherein the ultraviolet lamp is supported within the cooling jacket by metallic strips.

20. A thermal processing apparatus for a workpiece, comprising:
an insulated process chamber having walls;
a workpiece support positioned inside of the insulated process chamber;
an atmosphere control to control the atmosphere inside of the insulated process chamber;
a heater to heat the workpiece;
an ultraviolet light system to convey ultraviolet light to the workpiece, the ultraviolet light system having
a cooling assembly with a coolant space positioned inside of the process chamber and supported by the walls of the process chamber;
an ultraviolet lamp positioned inside the cooling assembly, the ultraviolet lamp comprising an ultraviolet discharge tube;
a lamp support supporting the ultraviolet lamp in a spaced relationship from the interior wall of the cooling assembly;
a coolant circulation system in thermal contact with a space inside of the cooling assembly;
a power supply electrically connected to the ultraviolet lamp;
a sensor that senses at least one of the group consisting of whether the ultraviolet lamp is on, how much power the ultraviolet lamp is consuming, and the temperature of the ultraviolet lamp; and
a controller that controls the heat and ultraviolet light present in the insulated process chamber.

21. A thermal processing apparatus for a workpiece, comprising:
an insulated process chamber having walls;
a workpiece support positioned inside of the insulated process chamber;
an atmosphere control to control the atmosphere inside of the insulated process chamber;
a heater to heat the workpiece;
an ultraviolet light system to convey ultraviolet light to the workpiece, the ultraviolet light system having
an ultraviolet lamp positioned outside of the insulated process chamber, the ultraviolet lamp comprising an ultraviolet discharge tube;
a cable having a first end and a second end, the first end being coupled to the ultraviolet lamp and the second end transmitting light from the ultraviolet lamp to the inside of the insulated process chamber;
a power supply electrically connected to the ultraviolet lamp;
a sensor that senses at least one of the group consisting of whether the ultraviolet lamp is on, how much power the ultraviolet lamp is consuming, and the temperature in the insulated process chamber;
a controller coupled to the sensor, the ultraviolet light source, and the heater, the controller controlling the heat and ultraviolet light present in the insulated process chamber; and
wherein the controller alters power to heater and ultraviolet light source depending on a condition sensed by the sensor.

22. The thermal processing apparatus of claim 21, wherein the walls of the insulated process chamber further comprise cable holes, and wherein the cable is positioned through the cable holes with the second end of the cable positioned inside of the insulated process chamber.
